(19) United States
(12) Patent Application Publication
(10) Pub. No.: US 2012/0290938 A1
(43) Pub. Date: Nov. 15, 2012

(54) Systems and Methods for Context Aware Interaction Across Websites and Apps

(75) Inventors: Murali B. Subbarao, Saratoga, CA (US); Shankar A. Chittoor, Fremont, CA (US); Allwyn Lobo, Campbell, CA (US)

(73) Assignee: Billeo, Inc., Santa Clara, CA (US)

(21) Appl. No.: 13/468,011

(22) Filed: May 9, 2012

Related U.S. Application Data
(60) Provisional application No. 61/484,828, filed on May 11, 2011.

(51) Int. Cl. G06F 3/048

(52) U.S. Cl. 715/738

(57) ABSTRACT

A system for context aware interaction across websites and apps is disclosed, including a context runtime engine configured to track online activity of a user across web pages, browser tabs, browsers, social networking apps, mobile apps and the like. The system includes a state machine module configured to track a context of user actions across web pages, browser tabs, browsers, social networking apps, mobile apps and the like. The system further includes an active context platform configured to interact with the context runtime engine and a plurality of databases to store information pertaining to the context of the user. A method for context aware interaction across websites and apps is also disclosed.

### CROSS-REFERENCE TO RELATED APPLICATION

This application claims benefit to U.S. Provisional Patent Application No. 61/484,828, filed on May 11, 2011, which is incorporated by reference in its entirety.

### TECHNICAL FIELD

The present disclosure is generally related to the world wide web and, more particularly, is related to context aware interaction across websites and apps.

### BACKGROUND

Since, the advent of the internet, tracking user browsing activity has been of interest. The user browser activity may provide valuable pointers to user interests and inclinations which can then be used for targeted advertising by website owners and online retailers. Several methods have been proposed for tracking user browser activity. A customized presentation on a Graphical User Interface (GUI) can be made to the user based on permanent browser cookies (may be referred to as ‘web cookies’ and ‘http cookies’) and session browser cookies set by a web publisher. Internet advertisers use browser cookies set in various websites to gain an understanding of an internet user profile.

The user browsing activity may be tracked by using server-based methods. When a web-browsing session between a user and a server is in progress, website access requests are originated by the user's browser. The requests are transmitted to a server. The server maintains a log of all the requests submitted by the user's browser. Typically, the server assigns an identifier to each browser that sends a website content access request. This enables the server to maintain the log of the pages and links that the browser requests access to. Internet advertisers may use the identifier to track the website usage tendency of the user.

However, the various methods of tracking user web-browsing activities do not provide intent of the user when they visit a website. For example, in a scenario in which the user is browsing a sportswear listing of a website that is selling multiple types of garments such as sportswear, casual wear, and the like and additionally, accessing another website's sports footwear section, tracking the website browsing activity of the user may only reveal their intent to buy sports gear which might not be the true intent. The actual reason due to which the user is looking to buy sports gear may be because he wants to join a gym, a sports club, and the like. Thus, not being able to understand the real intent behind a browsing activity causes forgoing of potential advertising opportunities in which the user could have been provided suggestions of listings of local gyms, fitness centers, and sport clubs.

Thus, there is a need to devise systems and methods that actively detect the browsing context and intent of the user and respond to the detected context in real-time, and which overcome shortcomings of the existing systems and methods.

### SUMMARY

Example embodiments of the present disclosure provide systems of context aware interaction across websites and apps. System includes a context runtime engine configured to track navigation across web pages, browser tabs, browsers, social networking apps, mobile apps and the like. The system includes a state machine module configured to identify the context of user actions across the web pages, browser tabs, browsers, social networking apps, mobile apps and the like. The system further includes an active context platform configured to interact with the context runtime engine and a plurality of databases to store information pertaining to the context of the user. Methods for determining interaction based on the user's context across websites and apps are also disclosed.

### BRIEF DESCRIPTION OF THE DRAWINGS

These and other features, aspects, and advantages of the present invention will become better understood when the following detailed description is read with reference to the accompanying drawings.

FIG. 1 is a block diagram of an example embodiment of a system of context aware interaction across websites and apps;

FIG. 2 is a block diagram of an example embodiment for implementing a context runtime engine of FIG. 1;

FIG. 3 is a block diagram of an example embodiment for implementing active context platform of FIG. 1; and

FIG. 4 is a flow chart of an example embodiment for defining context aware interaction across websites and apps.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. Furthermore, references to “an embodiment”, “embodiments”, “exemplary embodiment” and “example embodiment” of the claimed invention should not be interpreted as excluding the existence of additional embodiments that also incorporate the recited features.

Conventional methods do not actively track a context of the user while an internet browsing session is active. For example, in a scenario in which movie preferences of a middle-aged male user with no children are tracked over a period of time. It is observed that he typically orders action movies using online movie rental stores. However, on a weekend, contrary to his general preferences he orders several animation movies. There is a high probability that he has relatives with children visiting. This puts him in a different context than before. Deriving this changed context may provide a potential selling opportunity in which he can be offered a discount deal at a local amusement park. Thus, actively tracking the context of the user may provide an increased number of selling opportunities. The conventional methods do not actively track, determine, and respond to a user's context, leading to a loss of potential selling opportunities.

Browser cookies in a typical internet system neither provide intent of the user nor provide browsing context of the user while a web browsing (may also be referred to as “internet browsing”) session is active. For a predetermined web browser application (for example, “Internet Explorer” and “Firefox”), embodiments of the present disclosure have ability to track user navigation across web pages, websites, browser tabs. Additionally, for a predetermined app (such as mobile apps, tablet apps, social networking apps, and the like embodiments of the present disclosure have ability to track location, social graph, and so forth of the user. However, embodiments of the present disclosure provide a context runtime engine that uses a state machine to track user actions across the web pages and apps. The state machine is configured to provide insights into user's context and user's intent, thereby providing a holistic view of an association between user information (i.e., age, gender, and interests) and their actions and intents. This is in contrast to browser cookies that provide information relating only to user's actions and not pertaining to user's personality (including details such as age, gender, and interests). According to an exemplary embodiment of the present disclosure, product searches conducted by a user at a search engine and user's visit to product review pages are example transitions in the state machine.

In an example embodiment of the present invention, the term “context” is defined and elaborated. Conditions and circumstances that are relevant to an event and a fact are examples included in “context.” Examples of an event may include searching for a product, finding reviews of products, visiting a merchant site, checking out of a merchant website, completing a purchase, making a rental car reservation, completing purchase of a vacation package at a travel site, searching for information on a performing artist, referring a friend and the like. Context may include tracking user profile including demographic information such as age, gender, and home location, among others. Context may also include tracking user profile, including relationship with program sponsors such as an airline, type of credit card being used (silver, gold, platinum) or membership status based on number of flights taken (basic, premier, executive), and the like. Context may further include tracking user activity leading up to the event defined by states and sequence of state transitions. Context may also include specific conditions provided by the program sponsors including products, promotions, offers available for specific events, quantity, timing, pricing details, and the like. Context may include user response to previous interactions.

In an example embodiment of the systems and methods for context aware interaction across websites and apps disclosed herein, recognition of the context may trigger an interaction based on a message or sequence of messages to be communicated. The interaction may also be based on user actions made available during the interaction. The interaction may also be based on user response to this interaction.

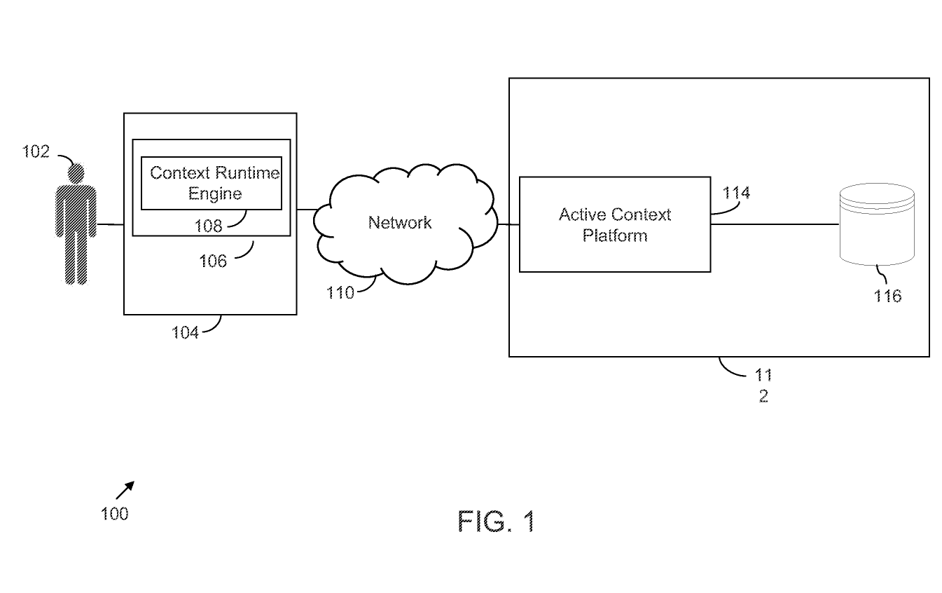

FIG. 1 illustrates a context aware interaction system 100 incorporating a user 102 whose web browsing intent and web browsing context should be determined, according to an example embodiment of the present disclosure. System 100 comprises user terminal 104 encasing one or more applications 106. In an example embodiment of the systems and methods for context aware interaction across websites and apps disclosed herein, user terminal 104 may include a personal computer (PC), a laptop, a tablet PC, a smart-phone, or any other device that can be used to access internet. At least one context runtime engine 108 is incorporated in applications 106. In an example embodiment of the systems and methods for context aware interaction across websites and apps disclosed herein, applications 106 may be internet browsers that provide internet access to user 102. In another example embodiment of the systems and methods for context aware interaction across websites and apps disclosed herein, applications 106 may include apps such as social networking apps, mobile phone apps, and the like. Context runtime engine 108 may also be referred to as a browser extension if user terminal 104 includes desktop computing systems.

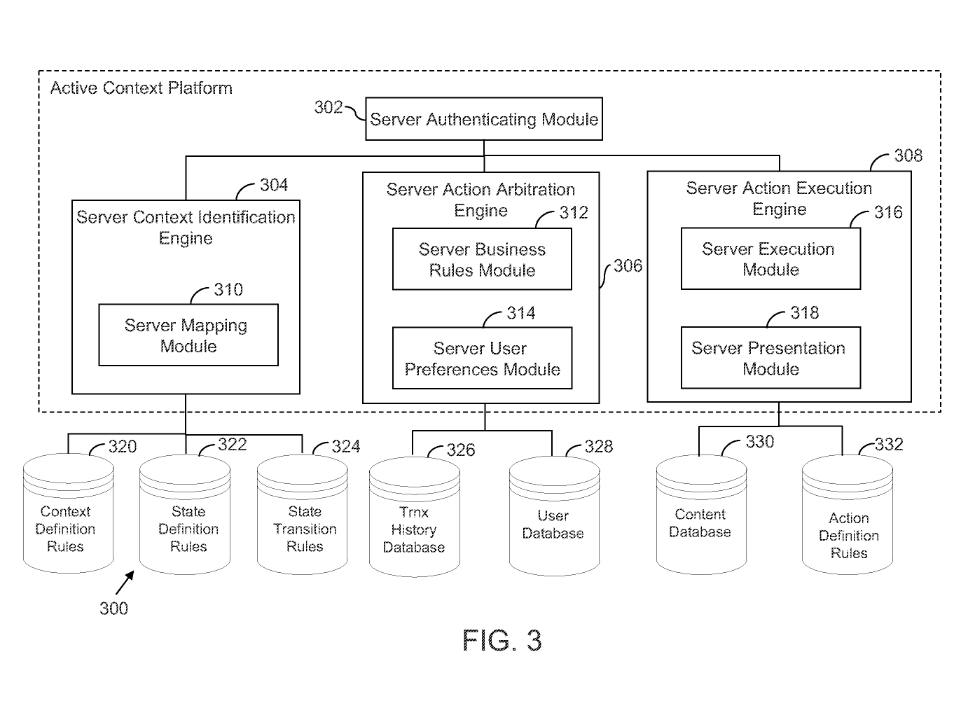

Network 110 couples user terminal 104 with server 112 that incorporates active context platform 114. Active context platform 114 is coupled with one or more databases 116 for accessing data corresponding to the user preferences, state definitions, user transaction history, and the like. Databases 116 are explained in detail in conjunction with FIG. 3 below. Active context platform 114 is configured to interact with context runtime engine 108 to fetch and store relevant information from databases 116.

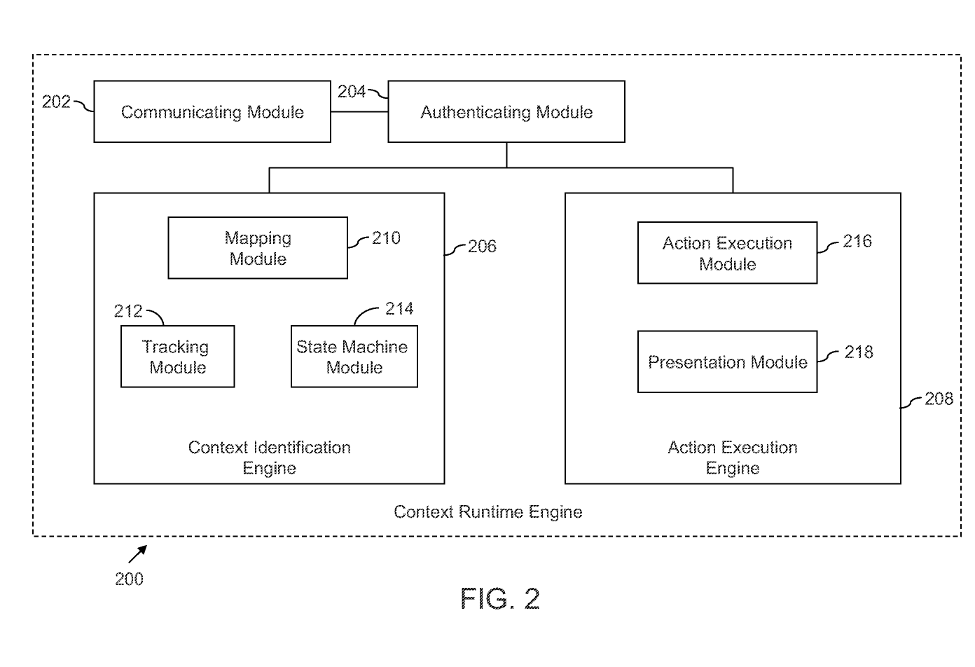

The elements of system 100 enable context aware interaction for user 102. The context may be a sequence of state transitions configured to derive logical interpretation of actions of user 102. Examples of the context may include shopping, bill pay and travel bookings, among others. In an example embodiment of the systems and methods for context aware interaction across websites and apps disclosed herein, context may further include recognition of vacation cruise booking at a travel website, identifying a checkout page at a merchant website, recognizing recurring bill payments through a credit card at a wireless service provider website, and so forth. The state transitions may be based on state definitions including a predetermined state for user 102. The predetermined state may include instances such as user 102 navigating a particular type of web page, a web page where user 102 is checking out a shopping cart, a login action by user 102 and the like. When user 102 navigates to any one of the desired states, context runtime engine 108 reports the desired state to server 112. Information pertaining to the desired state is stored for offline analytics which can define further interactions with user 102. The modules of context runtime engine 108 are explained in further detail in conjunction with FIG. 2

FIG. 2 illustrates example system 200 for implementing context runtime engine 108 incorporating communicating module 202, authenticating module 204, context identification engine 206, and action execution engine 208. Context identification engine 206 includes mapping module 210, tracking module 212, and state machine module 214. Action execution engine 208 includes action execution module 216 and presentation module 218.

Communicating module 202 is configured to communicate with server 112. Communicating module 202 further provides a base platform to other modules of system 200 to communicate with server 112. Authenticating module 204 is configured to authenticate user 102 with server 112 using communicating module 202.

Context identification engine 206 monitors the browsing navigation activities of a user. Based on the browsing navigation activities, context identification engine 206 identifies a context of the user. In an example, the browsing navigation activities include at least one of a count of times a webpage is visited, actions on the webpage visited, online forms submitted through the webpage, internet links clicked on the webpage, time spent on the webpage, and a sequence of websites visited that may include visiting a search engine, a product review site, and then a merchant site for a product category. In an example embodiment of the present invention, browsing activity of user 102 is tracked while user 102 browses internet using multiple tabs of a browser window. The browsing activity of user 102 is tracked by tracking module 212 when user 102 visits one or more Universal Resource Locators (URLs). In an example embodiment of the present invention, the browsing activity of user 102 is tracked when the user visits a predetermined list of URLs in which the predetermined list of URLs is obtained from server 112 via communicating module 202.

In another example embodiment of the systems and methods for context aware interaction across websites and apps disclosed herein, tracking user activity is not limited to tracking their website browsing activities, but rather includes tracking online user activity in one or more interaction channels such as a social networking app, a mobile app, and a website app. For example, a social networking activity of user 102 may include hitting the ‘like’ button of a picture of a tourist destination, a mobile phone, a fashion accessory, a dress, and the like by user 102. Additionally, the social network activity of user 102 may include the joining/creation of a social networking group corresponding to a specific interest. Further, the social network activity of user 102 may include expressing views, such as ‘tweeting’, regarding a newly launched product, a book, a restaurant, and the like. A context may be derived using the social networking activity that may include a ‘social graph’ of user 102 and stored in the user database. Further, tracking mobile activity of user 102 when user 102 uses a mobile app, such as Google Maps. The specific locations of user 102 and his activity such as searching for stores, restaurants, pubs, and movie theatres may be tracked that may further provide information that user 102 is visiting a suburb/town/city different from his place of living. Thereafter, tracking module 212 compares the tracked user browsing activity with the state definitions. In an example, the state definitions may include user 102 navigating to a particular type of webpage, a webpage where user 102 checks out a shopping cart, a login action by user 102, and the like. In an example embodiment of the systems and methods for context aware interaction across websites and apps disclosed herein, tracking module 212 obtains state definitions from server 112 via communicating module 202. In another example embodiment of the systems and methods for context aware interaction across websites and apps disclosed herein, tracking module 212 includes a set of pre-stored state definitions. In a scenario when user 102 reaches a targeted state specified in the state definitions, tracking module 212 informs state machine module 214.

State machine module 214 is configured to monitor a sequence of state transitions of user 102 while user 102 navigates from one state to another. In a scenario when user 102 follows a predetermined sequence of state transitions, state machine module 214 informs mapping module 210. In an example embodiment of the systems and methods for context aware interaction across websites and apps disclosed herein, state machine module 214 obtains state transition definitions from server 112 via communicating module 202. In another example embodiment of the systems and methods for context aware interaction across websites and apps disclosed herein, state machine module 214 includes a set of pre-stored state transition definitions.

Mapping module 210 identifies a context of user 102 based on the sequence of one or more state transitions. Mapping module 210 compares the sequence of the state transitions with a mapping between sequence of state transitions and corresponding contexts of user 102. If a match is obtained, mapping module 210 informs action execution engine 208 to execute actions corresponding to the identified context. In an example embodiment of the systems and methods for context aware interaction across websites and apps disclosed herein, mapping module 210 obtains the mapping between sequence of state transitions and corresponding contexts from server 112 via communicating module 202. In another example embodiment of the systems and methods for context aware interaction across websites and apps disclosed herein, mapping module 210 includes pre-stored mapping between sequence of state transitions and corresponding contexts. In an example embodiment of the systems and methods for context aware interaction across websites and apps disclosed herein, mapping module 210 transmits the identified context to active context platform 114 that in turn identifies an action corresponding to the context.

Action execution module 216 is directed by active context platform 114 to execute the action corresponding to the context. For example, the actions may include presenting an offer/recommendation to user 102, launching of relevant operating system level utilities, and the like. In an example embodiment of the systems and methods for context aware interaction across websites and apps disclosed herein, action execution module 216 identifies the action corresponding to the context based on a pre-stored mapping between one or more contexts and corresponding actions and thereafter executes the actions.

Presentation module 218 is configured to display offers and additional information, and to provide additional functionality based on the context of user 102. Action execution module 216 uses presentation module 218 to execute the actions corresponding to the context that need visual presentation to user 102. In an example embodiment of the systems and methods for context aware interaction across websites and apps disclosed herein, presentation module 218 may use various techniques such as a message within context runtime engine 108, overlaying a message on a webpage, overlaying multiple messages on a webpage, displaying selection of one of the multiple messages on a webpage by user 102 and the like. In another example embodiment of the systems and methods for context aware interaction across websites and apps disclosed herein, presentation module 218 provides a slide-bar having a plurality of messages. Further, once user 102 selects a particular message from the plurality of messages of the slide-bar, presentation module 218 displays additional messages related to the selected message in a different location of a display. In yet another example embodiment of the present invention, presentation module 218 may invoke server presentation module 318 of FIG. 3 for presenting dynamic content to user 102.

FIG. 3 illustrates example system 300 for implementing active context platform 114 incorporating server authenticating module 302, server context identification engine 304, server action arbitration engine 306, and server action execution engine 308. Server context identification engine 304 includes server mapping module 310. Server action arbitration engine 306 includes server business rules module 312 and server user preferences module 314. Server action execution engine 308 includes server execution module 316 and server presentation module 318. System 300 further incorporates context definitions rules database 320, state definition rules database 322, state transition rules database 324, transaction history database 326, user database 328, content database 330, and action definition rules database 332. FIG. 3 is explained in detail in conjunction with FIG. 2.

Server authenticating module 302 is configured to authenticate user 102 using user database 328. Authenticating module 204 transmits login credentials of user 102 to server authenticating module 302 through communicating module 202. Server authenticating module 302 accesses user database 328 to compare the received login credentials with stored login credentials. Thereafter, server authenticating module 302 transmits authentication fail/pass message to authenticating module 204.

Server context identification engine 304 supports context identification engine 206 during identification of context of user 102. Server mapping module 310 is configured to provide context runtime engine 108 information pertaining to a user's online activity that may include list of URLs of interest, social networking events of user 102 such as hitting the ‘like’ button of a picture of a tourist destination, a mobile phone, a fashion accessory, an apparel, and a changed location of user 102 in a scenario when user 102 visits a town/suburb/city. Server mapping module 310 provides the above information via communicating module 202. Further, server mapping module 310 provides context identification engine 206 with context definition rules from context definition rules database 320, one or more state definitions from state definition rules database 322, and one or more sequences of state transitions from state transition rules database 324. Examples of state of user 102 may include a login page, a sign out page, checkout page, payment confirmation page, and the like. The state definition rules for context runtime engine 108 include specific browsing patterns and web page structures to identify class and type of a web page.

Additionally, server context identification engine 304 also provides an interface to network administrators to maintain a list of context definition rules in context definition rules database 320, one or more state definitions in state definition rules database 322, and one or more sequences of state transitions in state transition rules database 324. In an example embodiment of the systems and methods for context aware interaction across websites and apps disclosed herein, server mapping module 310 identifies a context of user 102 based on the tracked sequence of state transitions by context identification engine 206. Here, server mapping module 310 performs tasks similar to mapping module 210.

Server action arbitration engine 306 identifies one or more actions corresponding to the context and content of the actions based on one or more server business rules and one or more user preferences. The server business rules are defined by server business rules module 312 according to which server action arbitration engine 306 operates. Examples of server business rules may include a rule that prioritizes the product warranty recommendation over offer when user 102 performed a high value purchase transaction, steering user 102 to merchant A over merchant B, when both merchants are located nearby current location of user 102, display offers activated by other people with similar user profile, and the like. In an example embodiment of the systems and methods for context aware interaction across websites and apps disclosed herein, the server business rules are derived by server business rules module 312 using the payment and purchase history, spending amount, category of purchases, bills paid, merchants where payments have been made of user 102, stored in transaction history database 326.

Further, preferences of user 102 are stored by server user preferences module 314 in user database 328. Examples of the user preferences may include, “do not show a user the offers or messages on a specific website”, “do not show specific offers”, “do not show already seen offers”, “free shipping offers over cash back offers”, “remind me of card benefits relating to travel when I'm doing travel related activity”, and the like. Additionally, user database 328 stores information of user 102 such as age, gender, and interests of user 102. User database 328 further includes information such as “how frequently does user 102 shop”, “how recently user 102 has shopped”, and the like. The user preferences are inputs for server action arbitration engine 306 to determine an appropriate action to be performed corresponding to the context that user 102 is in. In an example embodiment of the present invention, a set of predefined actions is transmitted to context runtime engine 108 by server action arbitration engine 306. The appropriate actions to be performed corresponding to the context of user 102 are then identified by context runtime engine 108. Additionally, server action arbitration engine 306 uses content database 330 to identify the opportunities to apply context aware interaction. Examples of content may include offers, recommendations, marketing messages, and consumer servicing, in which the offers are from various cards, affiliate networks, memberships that user 102 holds and the recommendations are from partner programs. For example, when user 102 makes a reservation at a car rental website, content database 330 is accessed to find a relevant marketing message relating to card benefits which is then provided to user 102.

Server action execution engine 308 executes the various actions identified by server action arbitration engine 306. Server execution module 316 executes the actions based on one or more offers, recommendations, marketing messages, and consumer servicing information stored in content database 330. Additionally, server execution module 316 executes the actions based on metadata corresponding to the actions stored in action definition rules database 332. Further, server execution module 316 uses server presentation module 318 for executing the actions that require presentation to user 102 by server 112.

Server presentation module 318 provides all the necessary information to presentation module 218 to present appropriate message to user 102. Given a predetermined context for user 102, server action arbitration engine 306 is configured to decide the most appropriate message to be provided to user 102. Based on the context, user 102 is shown at least one message sequence comprising an offer, a marketing message, a service message, and a new function, among others. In an example embodiment of the systems and methods for context aware interaction across websites and apps disclosed herein, server presentation module 318 acts as a support module for context runtime engine 108 in providing various formats and styles of presentation such as overlaying a message on a webpage, overlaying multiple messages on a webpage, displaying selection of one of the multiple messages on a webpage by user 102, a slide-bar having plurality of messages and the like. A decision to show an appropriate message may be based on a combination of business rules defined, consumer preferences and transactional history, among other factors. In another embodiment of the systems and methods for context aware interaction across websites and apps disclosed herein, server presentation module 318 acts as an execution platform for messaging when the message needs to be shown on any webpages hosted by the server visited by user 102.

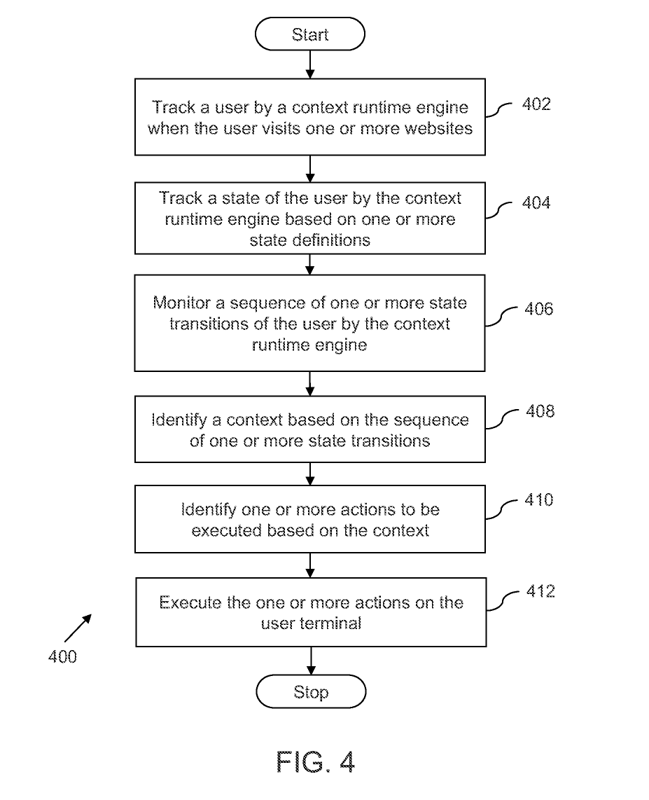

FIG. 4 illustrates example method 400 for enabling context aware interaction at one or more websites, in accordance with an example embodiment of the systems and methods for context aware interaction across websites and apps disclosed herein. Method 400 is explained in detail in conjunction with FIGS. 1, 2, and 3.

At block 402, user 102 is tracked by context runtime engine 108 when user 102 accesses the one or more websites. Context runtime engine 108 may be associated with an application, in which the application 106 may be installed at user terminal 104. At block 404, a state of user 102 is tracked by context runtime engine 108 based on one or more state definitions. The tracking of the various states of user 102 is explained in detail in conjunction with FIG. 2. At block 406, a sequence of one or more state transitions of user 102 is monitored by context runtime engine 108 based on one or more state transition definitions. The monitoring of the sequence of state transitions of user 102 is explained in detail in conjunction with FIG. 2. At block 408, a context of user 102 is identified based on the sequence of one or more state transitions using a mapping between the one or more state transitions and one or more contexts. In an example embodiment of the systems and methods for context aware interaction across websites and apps disclosed herein, the mapping between the one or more state transitions and one or more contexts is pre-stored at context runtime engine 108 and using that context runtime engine 108 identifies the context of user 102. The identification of the context of user 102 is explained in detail in conjunction with FIG. 2.

At block 410, one or more actions to be executed corresponding to the context are identified. In an example embodiment of the systems and methods for context aware interaction across websites and apps disclosed herein, the actions are identified by context runtime engine 108 using a pre-stored mapping between one or more contexts and corresponding actions. In another example embodiment of the systems and methods for context aware interaction across websites and apps disclosed hereinactive context platform 114 identifies the actions corresponding to the context. The identification of actions corresponding to the context of user 102 is explained in detail in conjunction with FIGS. 2 and 3. At block 412, the one or more actions are executed on user terminal 104. In an example embodiment of the systems and methods for context aware interaction across websites and apps disclosed herein, the actions are executed by context runtime engine 108. In another example embodiment of the systems and methods for context aware interaction across websites and apps disclosed herein, the actions are executed by active context platform 114. The execution of the actions is explained in detail with FIGS. 2 and 3.

The flow chart of FIG. 4 shows the architecture, functionality, and operation of a possible implementation of context aware interaction software. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (aCDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

What is claimed is:

1. A context runtime engine for enabling context aware interaction at one or more websites by a user, the context runtime engine associated with an application, and the application installed at a user terminal, the context runtime engine comprising:
a context identification engine, the context identification engine comprising:
a tracking module configured to:
a. track the user when the user visits one or more websites; and
b. track a state of the user based on one or more state definitions;
a state machine module configured to monitor a sequence of one or more state transitions of the user when the user visits the one or more websites;
a mapping module configured to identify a context based on the sequence of one or more state transitions; and
an action execution engine comprising an action execution module configured to identify and execute one or more actions based on the context.

2. The context runtime engine of claim 1 further comprising a communicating module configured to enable communication of the context runtime engine with an active context platform that runs on a server.

3. The context runtime engine of claim 2, wherein the sequence of one or more state transitions is monitored by the active context platform.

4. The context runtime engine of claim 2, wherein the context is identified by the active context platform.

5. The context runtime engine of claim 2, wherein the one or more actions are identified by the active context platform.

6. The context runtime engine of claim 2, wherein the one or more actions are executed by the active context platform.

7. The context runtime engine of claim 2 further comprising an authenticating module configured to authenticate the user with the server.

8. The context runtime engine of claim 2, wherein the one or more state definitions are provided by the active context platform.

9. The context runtime engine of claim 2, wherein one or more definitions for the one or more state transitions are provided by the active context platform.

10. The context runtime engine of claim 2, wherein the active context platform comprises a content database that enables identification of the context, the one or more actions corresponding to the context and content of the one or more actions.

11. The context runtime engine of claim 1, wherein the action execution engine further comprises a presentation module configured to present the user with information corresponding to the one or more actions based on the context.

12. The context runtime engine of claim 1, wherein the user terminal comprises at least one of a personal computer, a mobile phone, a smartphone, a laptop, a notebook, and a tablet.

13. A computer readable medium on which software is stored, the software comprising instructions for enabling context aware interaction at one or more websites by a user, the active context platform running on a server and communicating with a context runtime engine, the context runtime engine associated with an application, and the application installed at a user terminal, the instructions comprising:
a server context identification module, the server context identification module comprising:
a server mapping module configured to identify a context based on a sequence of one or more state transitions of the user identified by the context runtime engine;
a server action arbitration module, the server action arbitration module comprising:
a server business rules module configured to provide one or more business rules for execution of the server action arbitration engine; and
a server user preferences module configured to store one or more user preferences specified by the user, wherein the server action arbitration engine identifies one or more actions corresponding to the context based on the one or more server business rules and the one or more user preferences; and
a server action execution module configured to identify and execute the one or more actions on at least one of the server and the user terminal, wherein the one or more actions are executed on the user terminal by the context runtime module.

14. The computer readable medium of claim 13, wherein the server context identification module obtains a definition for the context from a context definition rules database.

15. The computer readable medium of claim 13, wherein the instructions obtain one or more state definitions from a state definition rules database configured to track a state of the user, wherein the state of the user is tracked by the context runtime module.

16. The computer readable medium of claim 13, wherein the instructions obtain a mapping between one or more state transitions and one or more contexts of the user from a state transition rules database configured to track a state and identify the context of the user, wherein the state of the user is tracked by the context runtime module.

17. The computer readable medium of claim 13, wherein the server action arbitration module and the server action execution module are configured to identify and execute the one or more actions based on a transaction of the user stored in a transaction history database.

18. The computer readable medium of claim 13, wherein the server user preferences module is configured to store one or more user preferences associated with the user in a user database.

19. The computer readable medium of claim 13, wherein the server action arbitration module and the server action execution module are configured to identify and execute the one or more actions based on one or more offers, recommendations, marketing messages, and consumer servicing information stored in a content database.

20. The computer readable medium of claim 13, wherein the server action arbitration module is configured to execute the one or more actions based on corresponding metadata stored in an action definition rules database.

21. The computer readable medium of claim 13, wherein the server action execution module comprises
a server execution module configured to identify and execute the one or more actions on the server.

22. The computer readable medium of claim 13, wherein the server action execution module comprises a server presentation module configured to execute the one or more actions needing presentation to the user by the server.

23. The computer readable medium of claim 13 further comprising a server authenticating module configured to authenticate the user with the server.

24. A method for enabling context aware interaction at one or more websites by a user, the method comprising:
tracking the user by a context runtime engine when the user visits the one or more websites, wherein the context runtime engine is associated with an application, wherein the application is installed at a user terminal;
tracking a state of the user by the context runtime engine based on one or more state definitions;
monitoring a sequence of one or more state transitions of the user by the context runtime engine based on one or more state transition definitions;
identifying a context based on the sequence of one or more state transitions using a mapping between the one or more state transitions and one or more contexts;
identifying one or more actions to be executed based on the context; and
executing the one or more actions on the user terminal.

25. The method of claim 24, wherein the one or more state definitions are provided by an active context platform running on a server.

26. The method of claim 25, wherein the one or more state transition definitions are provided by the active context platform.

27. The method of claim 26, wherein the context is identified by at least one of the context runtime engine and the active context platform.

28. The method of claim 27, wherein the one or more actions are identified by at least one of the context runtime engine and the active context platform.

29. The method of claim 28, wherein the one or more actions are executed on the server by the active context platform.

30. The method of claim 29, wherein the one or more actions are executed on the user terminal by at least one of the active context platform and context runtime engine.

31. A computer readable medium comprising a computer program product stored thereon, the computer program product comprising computer-executable instructions comprising:
tracking a user by a context runtime engine when the user visits one or more websites, wherein the context runtime engine is associated with an application, wherein the application is installed at a user terminal;
tracking a state of the user by the context runtime engine based on one or more state definitions, wherein the one or more state definitions are provided by a server;
monitoring a sequence of one or more state transitions of the user by the context runtime engine based on one or more state transition definitions provided by the server;
identifying a context based on the sequence of one or more state transitions using a mapping between the one or more state transitions and one or more contexts;
identifying one or more actions to be executed based on the context; and
executing the one or more actions on at least one of the server and the user terminal.
